(19) United States
(12) Patent Application Publication
(10) Pub. No.: US 2025/0028905 A1
(43) Pub. Date: Jan. 23, 2025

(54) MODEL AND VARIABLE SELECTION USING LARGE LANGUAGE MODEL

(71) Applicant: Tohid Atashbar, Bethesda, MD (US)

(72) Inventor: Tohid Atashbar, Bethesda, MD (US)

(21) Appl. No.: 18/355,443

(22) Filed: Jul. 20, 2023

(51) Int. Cl. G06F 40/284

(52) U.S. Cl. CPC G06F 40/284

(57) ABSTRACT

The present disclosure discloses a system to select an optimum model from a plurality of models. The system includes a connector configured to receive inputs from an interface. The system further includes a data structure configured to store a Large Language Model (LLM) that is pre-trained using a training data, obtain the inputs from the connector, and execute the LLM based on the training data and the inputs obtained from the connector to output LLM tokens, probabilities of LLM tokens and LLM parameters. Furthermore, the system includes a processor configured to process the output from the data structure or the LLM by executing a probabilistic interference algorithm, and select the model based on the processing of the output obtained from the data structure. The system additionally includes an output generator configured to receive the selected model from the processor and output the selected model.

### BACKGROUND OF THE INVENTION

### Field of the Invention

The present invention generally relates to a system and method for model and variable selection using Large Language Model (LLM), and more particularly to a system and method that uses LLM for selecting models, variables associated with models, calibrating parameters, and interpreting equations, relations and/or results in software applications in economic, econometric, financial or statistical domains.

### Description of the Related Art

Abundance of data (e.g., big data) has helped many industries to flourish and generate millions of jobs. For example, abundance of data has helped social networking firms, e-commerce firms, financial firms, etc. to utilize the data in productive and creative ways to provide better services and insights to their customers. Abundance of data has also helped these firms to perform predictive analytics, financial data research, customer sentiment analysis, etc., to enhance their product and service offerings.

While abundance of data provides many benefits, as data becomes larger and more complex, handling and analysis of oceans of data pose challenges for data researchers. For example, researchers working in economic, financial, or statistical fields need to select appropriate models, variables and/or parameters for their data analysis when they are operating a statistical or financial software application. Conventional selection of models, variables, parameters, etc. based on large data sets can be challenging, time-consuming and prone to error. Further, it requires specialized skills (in many cases, inter-disciplinary skills) and expertise on the part of the researcher to correctly select appropriate models, variables and/or parameters. Researchers with such skills and expertise are difficult to find, and have limited availability.

Conventional systems for automatically selecting models and/or variables have limited effectiveness, as they lack ability to search through all possible models or variables within a reasonable time duration (that may be acceptable to a user).

Furthermore, even if appropriate models, variables and/or parameters are selected, interpreting equations, relations within the models, and/or results obtained from the models is challenging, especially when the models use large data sets.

Accordingly, there is a need for a system and method that assists a user in selecting appropriate models, variables and/or parameters in a statistical or financial software application, and interpreting the results, equations when sifting through large data sources.

Embodiments of the present disclosure provide for a novel system and method for selecting an appropriate model from a plurality of models, and associated variables and parameters as described and defined in the description below and in the annexed claims that provide for improved efficiency and effectiveness in order to conveniently and more effectively select appropriate model, variables and parameters.

### SUMMARY OF THE INVENTION

The following presents a simplified summary of the present disclosure in a simplified form as a prelude to the more detailed description that is presented herein.

In accordance with embodiments of the invention, there is provided a system to select a statistical model (or “model”) from a plurality of statistical models, and variables, parameters, etc. associated with the selected model. The system includes a connector/Application Programming Interface (API)/bridge configured to receive inputs from an interface. In certain embodiments, the inputs include, but are not limited to, text, numerical values, user preferences, predefined settings of a statistical software application, and/or the like. The system further includes a data structure or a memory configured to store a Large Language Model (LLM) that may be pre-trained using a training data. The data structure is configured to obtain the inputs from the connector, and execute the LLM based on the training data and the inputs obtained from the connector to output one or more of LLM tokens, probabilities of LLM tokens and LLM parameters.

The system further includes a processor communicatively coupled with the data structure. The processor is configured to obtain the output from the data structure/LLM and process the output obtained from the LLM. In certain embodiments, the processor processes the output by executing a probabilistic interference algorithm. The processor is further configured to select the statistical model from the plurality of statistical models based on the processing of the output obtained from the LLM. The system further includes an output generator configured to receive the selected statistical model from the processor and output the selected statistical model.

In certain embodiments, in addition to selecting the model, the processor is configured to select one or more of data, variables and parameters associated with the selected model, based on the processing of the output obtained from the LLM.

In some embodiments, the system further includes a domain selector configured to receive a user selection of one or more domains of the model to be selected. The domain selector is further configured to transmit the user selection to the connector. Further, the connector is configured to transmit the user selection to the data structure, and the data structure is configured to execute the LLM based on the user selection.

In certain embodiments, the system further includes a data source configured to transmit data to the LLM to fine-tune the LLM.

In some embodiments, the system further includes a model executor communicatively coupled with the connector, the data structure/LLM and the processor. The model executor is configured to execute the selected statistical model based on the inputs received from the connector, the LLM parameters, and the one or more of the data, the variables and the parameters associated with the selected statistical model. The model executor is further configured to output results responsive to executing the selected model. The system further includes a visualizer configured to receive the results from the model executor, and determine an optimum output format based on the results and the inputs received from the connector. The visualizer is further configured to output the results in the determined optimum output format.

In accordance with another embodiment of the invention, there is provided a method to select a statistical model from a plurality of statistical models. The method includes obtaining, by a processor, output from a data structure. In some embodiments, the data structure is configured to store a Large Language Model (LLM) that is pre-trained using a training data and obtain inputs from an interface. The data structure is further configured to execute the LLM based on the training data and the inputs obtained from the interface to output one or more of LLM tokens, probabilities of LLM tokens and LLM parameters. The method further includes processing, by the processor, the output obtained from the data structure/LLM by executing a probabilistic interference algorithm. The method further includes selecting, by the processor, the model from the plurality of models based on the processing of the output obtained from the LLM. Furthermore, the method includes outputting, by the processor, the selected model via an output generator.

In accordance with yet another embodiment of the invention, there is provided a non-transitory computer-readable storage medium having instructions stored thereupon which, when executed by a processor, cause the processor to obtain output from a data structure. In some embodiments, the data structure is configured to store a Large Language Model (LLM) that is pre-trained using a training data and obtain inputs from an interface. The data structure is further configured to execute the LLM based on the training data and the inputs obtained from the interface to output one or more of LLM tokens, probabilities of LLM tokens and LLM parameters. The processor is further configured to process the output obtained from the data structure/LLM by executing a probabilistic interference algorithm, and select a statistical model from a plurality of statistical models based on the processing of the output obtained from the LLM. The processor is further configured to output the selected statistical model via an output generator.

The present disclosure discloses a system and method that uses LLMs to automatically or semi-automatically (based on user preferences) select, calculate, calibrate or process an optimum model, and associated variables, parameters, and equations from one or more datasets or a corpus of data or documents or any other data source in an economic, econometric, financial or statistical software. The system and method provides a novel way of model selection, calibration and result interpretation in economic, econometric, financial and other statistical software. The system and method further enables a user to conveniently and easily interpret the results output from the model, in the form of graphs, charts, heat maps, etc.

These and other features, aspects, and advantages of the present invention will become better understood with reference to the following description and appended claims.

### BRIEF DESCRIPTION OF THE DRAWINGS

Illustrative embodiments of the present invention are described herein with reference to the accompanying drawings, in which:

FIG. 1 is a schematic view of a system to select a model, in accordance with embodiments of the invention;

FIG. 2 is an example flowchart of the probabilistic interference to select variables, in accordance with embodiments of the invention;

FIG. 3 is a schematic view of LLM-based variable selection and model building, in accordance with embodiments of the invention; and

FIG. 4 depicts a flow diagram of a method to select a model, in accordance with embodiments of the invention.

### DETAILED DESCRIPTION OF INVENTION

For a further understanding of the nature and function of the embodiments, reference should be made to the following detailed description. Detailed descriptions of the embodiments are provided herein, as well as, the best mode of carrying out and employing the present invention. It will be readily appreciated that the embodiments are well adapted to carry out and obtain the ends and features mentioned as well as those inherent herein. It is to be understood, however, that the present invention may be embodied in various forms. Therefore, persons of ordinary skill in the art will realize that the following disclosure is illustrative only and not in any way limiting, as the specific details disclosed herein provide a basis for the claims and a representative basis for teaching to employ the present invention in virtually any appropriately detailed system, structure or manner. It should be understood that the devices, materials, methods, procedures, and techniques described herein are presently representative of various embodiments. Other embodiments of the disclosure will readily suggest themselves to such skilled persons having the benefit of this disclosure.

Reference will now be made in detail to the present preferred embodiments of the invention, examples of which are illustrated in the accompanying drawings. Wherever possible, the same reference numerals are used in the drawings and the description to refer to the same or like parts.

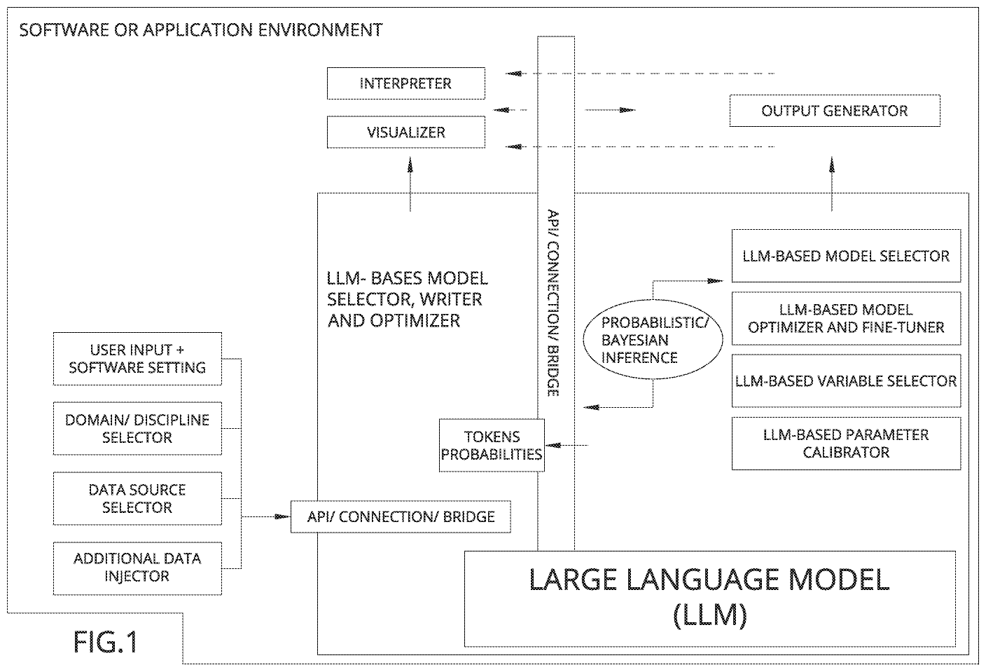

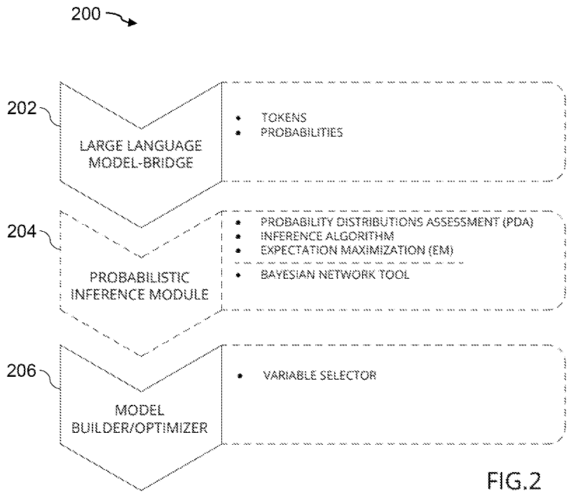

FIG. 1 is a schematic view of a system 100 to select a model, in accordance with embodiments of the invention. Specifically, FIG. 1 is a schematic view of the system 100 to select a statistical, financial, economic or econometric model from a plurality of models in a financial or statistical software application by using Large Language Model (LLM). While describing FIG. 1, references will be made to FIG. 2, which depicts a flowchart 200 of the probabilistic interference to select variables.

In some embodiments, the system 100 includes one or more modules or units including. but not limited to, a user input interface 102, a data structure or memory 104 storing an LLM, an Application Programming Interface (API)/bridge/connector 106, an LLM-based model or variable selector/calibrator/processor 108, and an LLM-based output generator 110. In certain embodiments, the system further includes one or more optional units including, but not limited to, a discipline/domain optimizer or selector 112, a data source selector or data source 114, an additional data injector 116, an LLM-based model executor and/or interpreter 118, an LLM-based visualizer 120, an LLM-based model optimizer and fine-tuner 122, an LLM-based variable selector 124, and an LLM-based parameter calibrator 126.

The user interface 102 is configured to receive inputs from a user or predefined settings from the statistical or financial software. In some embodiments, the inputs include text, numerical values, user preferences, and/or the like. The user interface 102 transmits the inputs and/or the settings to the connector 106. The connector 106 is configured to receive the inputs and/or the settings from the user interface 102, and transmit the received inputs and/or the settings to the memory 104 storing the LLM. Hereinafter, the terms “memory 104” and “LLM 104” are interchangeably used in the description below.

In some embodiments, the memory 104 stores programs in code and/or stores data for performing various operations in accordance with the present disclosure. The processor 108 is configured and/or programmed to execute computer-executable instructions stored in the memory 104 for performing various functions in accordance with the disclosure. Consequently, the memory 104 is used for storing code and/or data code and/or data for performing operations in accordance with the present disclosure.

In one or more embodiments, the processor 108 is disposed in communication with one or more memory devices. The memory 104 can include any one or a combination of volatile memory elements (e.g., dynamic random-access memory (DRAM), synchronous dynamic random access memory (SDRAM), etc.) and can include any one or more nonvolatile memory elements (e.g., erasable programmable read-only memory (EPROM), flash memory, electronically erasable programmable read-only memory (EEPROM), programmable read-only memory (PROM), etc.).

The memory 104 is one example of a non-transitory computer-readable medium and stores programs in code and/or stores data for performing various operations in accordance with the disclosure. The instructions in the memory 104 can include one or more separate programs, each of which can include an ordered listing of computer-executable instructions for implementing logical functions.

In certain embodiments, the LLM 104 is pre-trained using a training data. Responsive to obtaining the inputs from the user and/or the software settings from the connector 106, the LLM 104 is executed based on the training data and the inputs/settings obtained from the connector 106 to output one or more of LLM tokens, probabilities of LLM tokens and LLM parameters 128.

The processor 108 obtains the output from the LLM 104, and processes the output obtained from the LLM 104. In certain embodiments, the processor 108 processes the output by executing a probabilistic interference algorithm (that may be pre-stored in the system 100). A person ordinarily skilled in the art may appreciate that probabilistic interference is an operation of deriving probabilities of one or more random variables (e.g., unknown variables) taking a specific value or set of values. In some embodiments, the processor 108 may execute the algorithm based on Bayesian inference. An example flowchart 200 depicting the steps executed by the processor 108 to perform probabilistic interference to select variables is depicted in FIG. 2, as described below.

At step 202, the processor 108 obtains the LLM tokens, probabilities of LLM tokens and LLM parameters 128 from the LLM 104. At step 204, the processor 108 executes a probabilistic interference module (not shown) of the system 100 to perform/execute probability distribution assessment (PDA), expectation maximization (EM), interference algorithm, Bayesian network tool, and/or the like. At step 206, the processor 108, via the LLM-based model optimizer and fine-tuner 122 and the LLM-based variable selector 124, derives or selects variables (e.g., unknown variables, and their probabilities thereof) based on the execution of the probabilistic interference module at the step 204.

Responsive to executing the probabilistic interference module and based on the output obtained from the LLM 104 and the inputs/settings obtained from the connector 106, the processor 108 selects an optimum model(s) (e.g., a statistical model) from a plurality of models. In some embodiments, the processor 108 also selects, via the LLM-based variable selector 124 and the LLM-based parameter calibrator 126, one or more of data, variables and parameters associated with the selected model(s), based on the execution of the probabilistic interference module, the output obtained from the LLM 104 and the inputs/settings obtained from the connector 106.

In certain embodiments, the domain selector 112 enables the user to specify the domain(s) or discipline(s) of data, model, variables and/or parameters to be selected. Stated another way, the domain selector 112 is configured to receive a user selection of domains or disciplines of the model to be selected. The domain selector 112 transmits the user selection to the connector 106, which further transmits the user selection to the LLM 104. Responsive to receiving the user selection, the LLM 104 is executed to output the LLM tokens, probabilities of LLM tokens and LLM parameters 128 (as described above), based on the user selection. In this case, the processor 108 selects the model, data, variables and/or parameters, based on the user selection of the domains or the disciplines.

In further embodiments, the data source 114 and/or the additional data injector 116 enables the user to enrich the data used in the LLM 104 (in other words, enrich the LLM 104 for specialized tasks). Responsive to receiving user's inputs to enrich the LLM 104, the data source 114 and/or the additional data injector 116 transmits additional data (based on user's inputs) to the connector 106. The connector 106 transmits the additional data to the LLM 104, and the LLM-based model optimizer and fine-tuner 122 enriches or fine-tunes the LLM 104 based on the additional data.

In some embodiments, the LLM 104 may be trained (using the training data and the additional data) to recognize patterns in a given data set and assign probabilities to different tokens based on these patterns. This enables the LLM 104 to make accurate selections of variables, parameters and models, while still taking into account the user's preferences and software settings, as described above. The LLM 104 may also be trained to identify relationships between variables and models, and further refine token selection based on these relationships. This allows the LLM 104 to select more precise models and variables that are tailored to the user's data requirements.

The further embodiments, the processor 108 may also be used to select and process models and variables from different disciplines and areas. For example, the processor 108 may use or select a combination of economic, financial, and statistical models and variables to create an interdisciplinary model (as the output from the processor 108). The interdisciplinary model may be used to evaluate multiple markets and sectors simultaneously, thus helping the user to take informed decisions backed by optimum and accurate data, models, variables and parameters. Additionally, the processor 108 (based on the output obtained from the LLM 104) may identify relationships between variables from different disciplines and suggest a combination of models and variables that account for this relationship. This can be used to create more comprehensive and accurate models, improving the accuracy of the output from the processor 108.

In certain embodiments, responsive to the processor 108 selecting optimum model(s), data, variables and parameters, the processor 108 may output the model(s), data, variables and parameters to the output generator 110. The output generator 110 may receive this information from the processor 108, and may output the information (i.c., the model(s), data, variables and parameters) for the user, e.g., via the user interface 102.

In some embodiments, the LLM-based model executor and/or interpreter 118 leverages the LLM's trained parameters to execute the selected model(s) based on the inputs/settings received from the connector 106, the data, variables, and the LLM parameters 128. Responsive to executing the model, the LLM-based model executor and/or interpreter 118 outputs results. In certain embodiments, the LLM-based model executor and/or interpreter 118 may be configured to interpret the results, and identify patterns, relationships, and dependencies between variables and models and apply them to the results. The LLM-based model executor and/or interpreter 118 may also be configured to detect anomalies in the results and provide inputs to the user indicating possible reasons for the anomalies. The LLM-based model executor and/or interpreter 118 may also be configured to compare different models and variables or a set of calibrations or results to identify the most accurate or desirable results/output.

The LLM-based visualizer 120 may be configured to receive the results/output from the LLM-based model executor and/or interpreter 118, and then produce the output (c.g., on the user interface 102) in different formats such as tables, charts, graphs, and heat maps, etc., allowing the user to better understand and visualize the results. The LLM-based visualizer 120 may further determine an optimum output format or tailor/customize the output format based on the user's preferences and the results obtained from the LLM-based model executor and/or interpreter 118. The LLM-based visualizer 120 may further enable the user to customize the output/visualizations or export the output to other applications. This helps to make the output/results more accessible and understandable for the user. The LLM-based visualizer 120 may be further configured to output the results/output in the determined optimum output format or the customized format desired by the user.

A person ordinarily skilled in the art may appreciate from the description above that to configure or prepare the system 100, the user or an operator may first obtain and configure an LLM (e.g., the LLM 104, manufactured on-site or sourced from third parties) that is designed for Natural Language Processing (NLP) and deep learning (DL). The user may then develop a user input interface (e.g., the user interface 102) that is able to receive inputs from the user or financial/statistical software settings. The user may then create an optional domain selector that may be used to specify domain(s) or discipline(s) of the data, model, variables or parameters to be selected, processed or calibrated. The user may further integrate a data source (e.g., the data source 114 and/or the additional data injector 116) into the system 100, which is able to pass additional data to the LLM or fine-tune the LLM with more or new data.

Further, the user may develop a connector or bridge (e.g., the connector 106) between the user interface, the financial/statistical software, and the LLM that facilitates the transfer of data from one component to the other. Furthermore, the user may create an LLM-based model/variable selector/processor/calibrator (e.g., the processor 108)) that is able to process the output from the LLM, arrange, fine-tune, or process them based on the likelihood or probability of the tokens, or other measures requested/defined/set by the user or the software. The user may additionally develop an LLM-based model executor and/or interpreter (e.g., LLM-based model executor and/or interpreter 118) that may be able to leverage the LLM output to execute the model or interpret the results.

In addition, the user may create an LLM-based output generator (e.g., the output generator 110) and/or visualizer (e.g., the LLM-based visualizer 120) that may be able to produce the output in different formats such as tables, charts, graphs, and heat maps. The user may further test and debug the system 100 to ensure that it is functioning correctly. The user may finally deploy the system 100 and use it to automatically and semi/non-automatically select, process, and calibrate variables or models for use in economic, econometric, financial or statistical software.

To make the system 100 work better, the user may add other components or elements such as an interdisciplinary module (not shown). The interdisciplinary module enables the LLM 104 to select a variety of models and variables from different disciplines that are best suited to the data set provided by the user and user's preferences/software settings. In addition, the user may add a search feature to enable users to search for and locate specific models and variables.

Further, a person ordinarily skilled in the art may appreciate from the description above that the system 100 may be used in other fields of technologies (e.g., different from economic or financial fields) such as social sciences, humanities, medical science such as medical diagnostics and prognostics, and/or the like. As an example, the system 100 may be used to automatically and semi-automatically select, process, and calibrate variables or models for use in medical software, such as those used for diagnostics or prognostics. As another example, the system 100 may be used in software that is used for psychology or sociology. For example, the system 100 may be used to identify patterns in a given data set (e.g., data related to human behavior) and assign probabilities to different tokens based on these patterns, enabling the software to make more accurate selections of variables and models, while still taking into account the user's preferences. This can help to improve the accuracy of the output and provide users with more accurate and comprehensive insights.

The system 100 may also be used to generate more accurate software/devices that use LLM-based quantitative models. For example, a marketing analytical framework can be developed that uses the LLM-based automatic or semi-automatic quantitative modeling, as disclosed in the present disclosure, to analyze customer data and predict customer behavior, which updates itself to include newer variables/factors (even from non-economic fields) that affect markets.

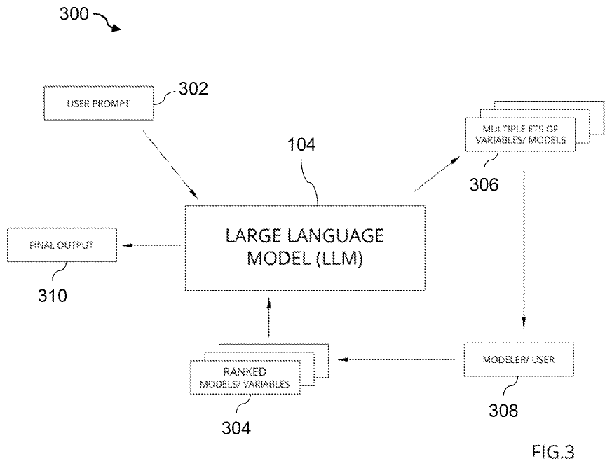

FIG. 3 is a schematic view 300 of LLM-based variable selection and model building (e.g., during training or learning phase of the LLM 104), in accordance with embodiments of the invention. As shown in FIG. 3, the LLM 104 may receive a user prompt 302 (e.g., the user inputs described above in conjunction with FIG. 1) and models/variables or ranked models/variables 304. Responsive to receiving this information, the LLM 104 may output multiple sets of variables/models 306, and a modeler/user 308 may optimize the output from the LLM 104 to form a feedback loop. The inputs from the modeler/user 308 may be used by the LLM 104 to further enhance or refine the ranked models/variables 304, during the learning phase or model-building phase of the LLM 104. Once an acceptable level of accuracy is reached, the LLM 104 may be trained to provide a final output 310 (same as the output from the LLM 104 described above in conjunction with FIG. 1).

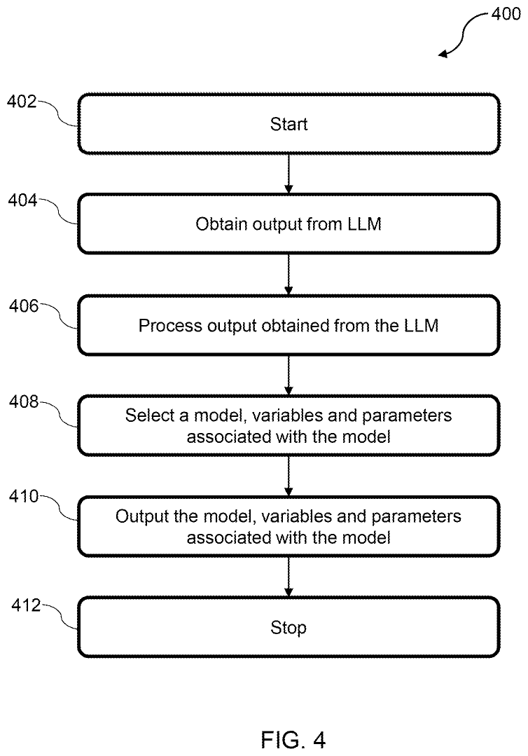

FIG. 4 depicts a flow diagram of a method 400 to select a model, in accordance with embodiments of the invention. FIG. 4 may be described with continued reference to prior figures, including FIGS. 1-3. The following process is exemplary and not confined to the steps described hereafter. Moreover, alternative embodiments may include more or less steps than are shown or described herein and may include these steps in a different order than the order described in the following example embodiments.

The method 400 starts at step 402. At step 404, the method 400 includes obtaining, by the processor 108, the output from the LLM 104. At step 406, the method 400 includes processing, by the processor 108, the output obtained from the LLM 104. At step 408, the method 400 includes selecting, by the processor 108, an optimum model, and variables and parameter associated with the model, based on the processing of the output obtained from the LLM 104. At step 410, the method 400 includes outputting, by the processor 108, the selected model, variables and parameters.

At step 412, the method 400 ends.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

This invention is susceptible to considerable variation within the spirit and scope of the appended claims.

The claimed invention is:

1. A system to select a statistical model from a plurality of statistical models, the system comprising:
a connector configured to receive inputs from an interface;
a data structure configured to store a Large Language Model (LLM) that is pre-trained using a training data, and wherein the data structure is further configured to:
obtain the inputs from the connector; and
execute the LLM based on the training data and the inputs obtained from the interface to determine a probability of each LLM token input through the interface, wherein each said probability is based on relationships between variables and models identified by the LLM during pre-training;
a processor communicatively coupled with the data structure, wherein the processor is configured to:
obtain the output from the data structure;
process the output obtained from the data structure by executing a probabilistic interference algorithm based on the probabilities of LLM tokens;
select the statistical model from the plurality of statistical models based on processing of the output obtained from the data structure; and
an output generator configured to receive the selected statistical model from the processor and output the selected statistical model.

2. The system of claim 1, wherein the inputs comprise at least one of: text, numerical values, user preferences, and predefined settings of a statistical software application.

3. The system of claim 1 further comprising a domain selector configured to receive a user selection of one or more domains of the statistical model to be selected, wherein:
the domain selector is configured to transmit the user selection to the connector,
the connector is further configured to transmit the user selection to the data structure, and
the data structure is further configured to execute the LLM based on the user selection.

4. The system of claim 1 further comprising a data source configured to transmit data to the LLM to fine-tune the LLM.

5. The system of claim 1, wherein the processor is further configured to select one or more of data, variables and parameters associated with the selected statistical model, based on the processing of the output obtained from the data structure.

6. The system of claim 5 further comprising a model executor communicatively coupled with the connector, the data structure and the processor, wherein the model executor is configured to:
execute the selected statistical model based on the inputs received from the connector, the LLM parameters, and the one or more of the data, the variables and the parameters associated with the selected statistical model; and
output results responsive to executing the selected statistical model.

7. The system of claim 6 further comprising a visualizer configured to:
receive the results from the model executor;
determine an optimum output format based on the results and the inputs received from the connector; and
output the results in the determined optimum output format.

8. A method to select a statistical model from a plurality of statistical models, the method comprising:
obtaining, by a processor, output from a data structure, wherein the data structure is configured to:
store a Large Language Model (LLM) that is pre-trained using a training data;
obtain inputs from an interface; and
execute the LLM based on the training data and the inputs obtained from the interface to determine a probability of each LLM token input through the interface, wherein each said probability is based on relationships between variables and models identified by the LLM during pre-training;
processing, by the processor, the output obtained from the data structure by executing a probabilistic interference algorithm based on the probabilities of LLM tokens;
selecting, by the processor, the statistical model from the plurality of statistical models based on processing of the output obtained from the data structure; and
outputting, by the processor, the selected statistical model via an output generator.

9. The method of claim 8, wherein the inputs comprise at least one of: text, numerical values, user preferences, and predefined settings of a statistical software application.

10. A non-transitory computer-readable storage medium having instructions stored thereupon which, when executed by a processor, cause the processor to:
obtain output from a data structure, wherein the data structure is configured to:
store a Large Language Model (LLM) that is pre-trained using a training data;
obtain inputs from an interface; and
execute the LLM based on the training data and the inputs obtained from the interface to output one or more of: LLM tokens, probabilities of LLM tokens and LLM parameters;
process the output obtained from the data structure by executing a probabilistic interference algorithm;
select a statistical model from a plurality of statistical models based on processing of the output obtained from the data structure; and
output the selected statistical model via an output generator.
